(19) United States
(12) Patent Application Publication
(10) Pub. No.: US 2016/0210273 A1
(43) Pub. Date: Jul. 21, 2016

(54) IN-MEMORY WORKSPACE MANAGEMENT

(71) Applicant: SAP SE, Walldorf (DE)

(72) Inventors: Rakesh Kelappan, Bangalore (IN); Abhishek Nagendra, Bangalore (IN); Scott Cameron, Vancouver, CA (US)

(21) Appl. No.: 14/712,928

(22) Filed: May 15, 2015

(30) Foreign Application Priority Data
Jan. 15, 2015 (IN) 234/CHE/2015

(51) Int. Cl. G06F 17/22; G06F 17/24

(52) U.S. Cl. CPC G06F 17/2288; G06F 17/24

(57) ABSTRACT

In in-memory workspace management, a request is received from a user to open a document. It is determined whether the document is opened. Upon determining that the document is already opened, an existing workspace instance corresponding to the opened document is shared with the user. A mapping between the workspace request identifier and a workspace identifier is maintained in a workspace map. A reference count mapped to the workspace identifier is incremented since the existing workspace instance is shared with the user. It is determined whether the document is edited. The shared workspace instance is discontinued from sharing and is forked to create a new workspace instance for editing. The mapping between workspace request identifier and workspace identifier is removed from the workspace map. The reference count map is updated to decrement the reference count corresponding to the workspace identifier.

The present patent application claims the priority benefit of the filing date of Indian Provision Application No. 234/CHE/2015, filed 15 Jan. 2015, titled “WORKSPACE MANAGER IN LUMIRA, EDGE EDITION”.

### FIELD

Embodiments of the invention generally relate to data processing, and more particularly to methods and systems of in-memory workspace management.

### BACKGROUND

Enterprises use data analytics/analysis applications where documents may be created for analysis and collaboration within a group of users. The documents stored in repositories may be shared with various users such as members of a team or project. The members of a team or project may view or edit the documents. When a member of a team accesses a document, the document is loaded into a memory, and unloaded from the memory when the document is closed. For individual access by individual team members, the documents are loaded and unloaded individually in the memory. With loading and unloading the documents multiple times, the memory consumption increases linearly, accordingly the response time of accessing and opening the documents increases.

### BRIEF DESCRIPTION OF THE DRAWINGS

The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating an exemplary in-memory workspace management environment, according to an embodiment.

FIG. 2 illustrates a user interface listing documents in an analytics application, according to an embodiment.

FIG. 3 is a block diagram illustrating in-memory workspace management architecture, according to an embodiment.

FIG. 4 is a block diagram illustrating an exemplary in-memory workspace management system, according to one embodiment.

FIG. 5 is a flow diagram illustrating in-memory workspace management, according to one embodiment.

FIG. 6 is a block diagram illustrating an exemplary computer system, according to one embodiment.

### DETAILED DESCRIPTION

Embodiments of techniques for in-memory workspace management are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

A document may be created in a data analytics/analysis application for sharing and collaborating within a team. Some data analysis applications enable data manipulation and data visualization. A document is a file that contains connection parameters to data source, dataset including tables, graphical representations of data using the dataset, etc. When the document is saved, the document may be stored in a repository for members or users in the team to access the document. The document is loaded into memory for a user to view and edit the document. Alternatively, an existing document may be loaded from various data sources such as CSV file, MS Excel, RDBMS, etc. Memory may be an in-memory database using volatile memory storages such as RAM, DRAM, etc. In-memory database typically relies on main memory (volatile memory) for computation and storage.

The document along with tables, graphical representations, etc., loaded into memory is referred to as a workspace or a workspace instance. Workspace and workspace instance may be used interchangeably. When a user completes working with the document, the document is closed, and the workspace instance is unloaded from the memory. A workspace manager component may optimize loading and unloading of the workspace instances into and out of the memory. When multiple users open or access the same document, the workspace manager component enables reusing the workspace instance already loaded in the memory for multiple users. If multiple users access documents from a same data source, the workspace manager may enable reusing the workspace instance already loaded in the memory for the multiple users. In this way, duplicate loading of the same document in memory is avoided. Individual users may have exclusive set of user metadata in their individual sessions while accessing the shared workspace instance.

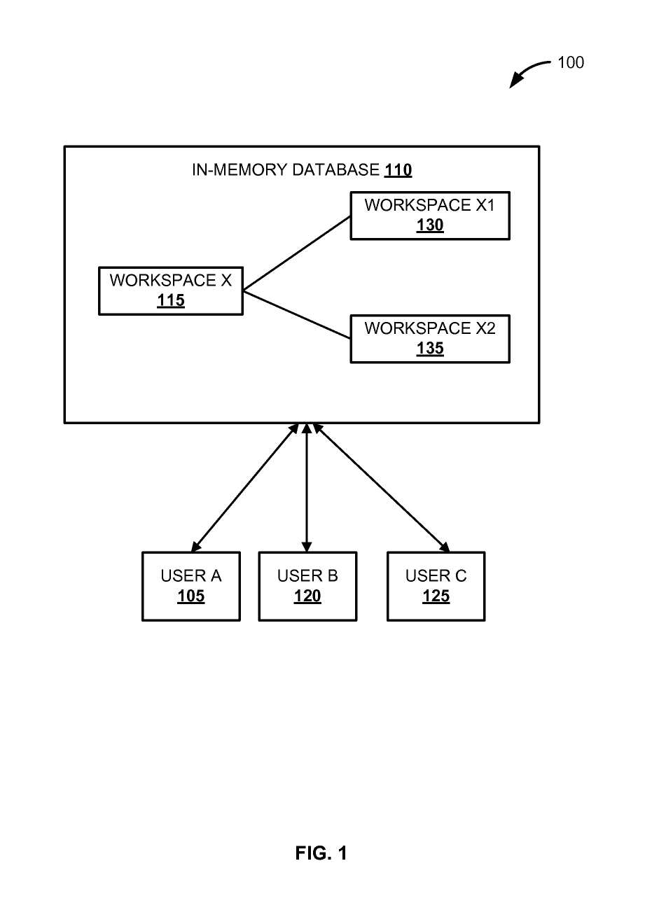

FIG. 1 is a block diagram illustrating an exemplary in-memory workspace management environment 100, according to one embodiment. With reference to FIG. 1, when ‘user A’ 105 accesses ‘document X’ in a repository, ‘document X’ along with tables associated with ‘document X’ is loaded into an in-memory database 110 creating ‘workspace X’ instance 115 for ‘user A’ 105. When ‘user B’ 120 and ‘user C’ 125 access ‘document X’, ‘workspace X’ instance 115 is shared with ‘user B’ 120 and ‘user C’ 125, and no new workspace instance is additionally created. ‘User A’ 105, ‘user B’ 120 and ‘user C’ 125 may simultaneously access and work on the shared ‘workspace X’ instance 115, the users may have individual exclusive sessions established to the ‘workspace X’ instance 115 with individual user metadata.

For example, when ‘user A’ 105 refreshes data in ‘document X’ or modifies data in ‘document X’, sharing of ‘workspace X’ instance 115 is stopped for ‘user A’ 105, and the ‘workspace X’ instance 115 is forked to create a new workspace ‘workspace X1’ instance 130 for ‘user A’ 105. Fork or forking refers to the process of branching or creating a separate/independent instance of the current workspace. The separate workspace instance is a current copy of the existing workspace instance. ‘User A’ 105 works on the ‘workspace X1’ instance 130 that is exclusive to ‘user A’ 105. The refreshed data is loaded in tables in ‘workspace X1’ instance 130 for ‘user A’ 105. Further request to refresh document and/or modify document by ‘user A’ 105 is in ‘workspace X1’ instance 130, because it is not a shared workspace instance. ‘User B’ 120 and ‘user C’ 125 continue to work on shared workspace instance ‘workspace X’ 115 until either of the users modify ‘document X’.

When ‘user B’ 120 adds visualizations or graphical representations to ‘document X’, sharing of ‘workspace X’ instance 115 is stopped for ‘user B’ 120, and the ‘workspace X’ instance 115 is forked to create a new workspace instance ‘workspace X2’ 135 for ‘user B’ 120. The added visualizations are saved in ‘document X’ in the data repository. ‘Workspace X2’ instance 135 becomes the new base workspace instance for ‘document X’. Further access to ‘document X’ by a different user is provided with the ‘workspace X2’ instance 135 with the added visualizations.

In one embodiment, when ‘user A’ 105 accesses a new document ‘document Y’, ‘document Y’ along with tables associated with ‘document Y’ is loaded into the in-memory database 110, creating ‘workspace Y’ instance for ‘user A’ 105. In one embodiment, a new document ‘document Z’ shares a same data source as the ‘document Y’. When ‘user C’ 125 accesses ‘document Z’, ‘workspace Y’ instance with data corresponding to ‘document Z’ is shared with ‘user C’ 125, since ‘document Z’ and ‘document Y’ share the same data source. New workspace instance is not provided for ‘user C’ 125. When individual users sharing the ‘workspace Y’ instance close the respective instances of documents opened by them, ‘workspace Y’ instance is closed, and the tables associated with the ‘workspace Y’ instance are deleted from in-memory database 110.

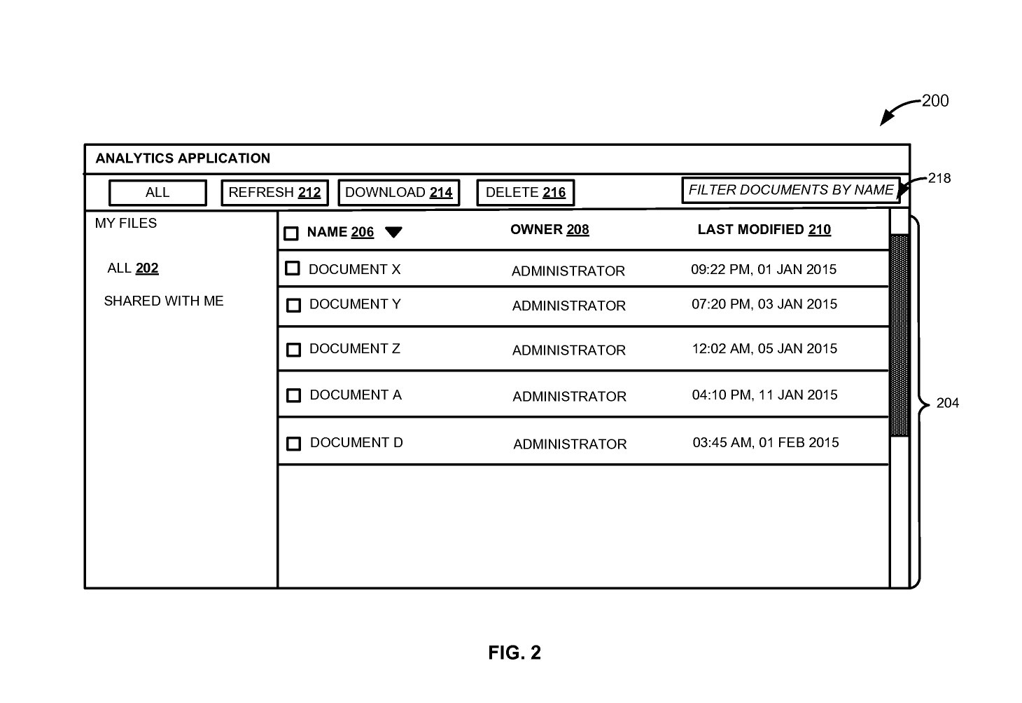

FIG. 2 illustrates user interface 200 listing documents in an analytics application, according to one embodiment. When a user selects ‘all’ 202 option, the documents available in a repository are displayed to the user in the window 204. Individual documents are displayed with name of the document in name 206 column, owner of the document in owner 208 column, and the time stamp when the document was last modified in the last modified 210 column. Refresh button 212 is used to refresh the list of documents displayed in the window 204. Documents may be downloaded using the download button 214, and deleted using the ‘delete’ button 216. The listed documents can be filtered by typing the name of the document in the search box 218. When individual documents are clicked, the documents are opened and displayed on the screen with appropriate data/dataset. Users can create graphical representations, edit, modify, and perform various other activities with the document.

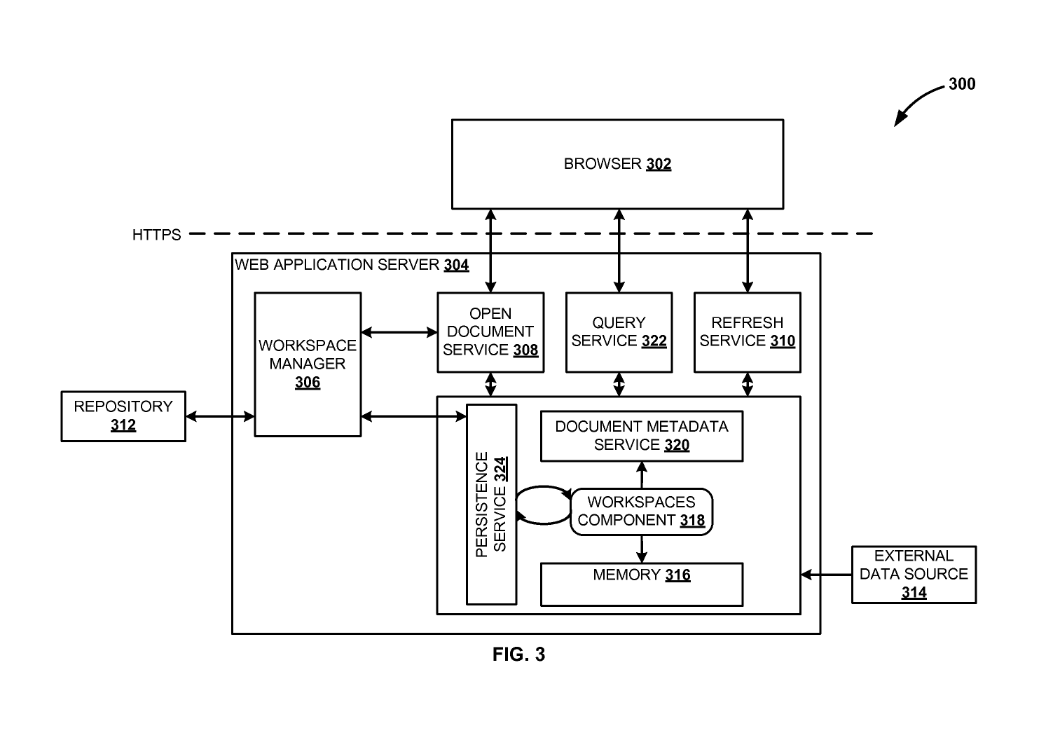

FIG. 3 is a block diagram illustrating in-memory workspace management architecture 300, according to one embodiment. Requests for accessing documents are received from browser 302, e.g, accessing an analytics application. The requests are received at web application server 304 or webserver. ‘Workspace manager’ 306 performs various tasks such as optimizing workspace loading, performing initial memory heuristics before opening documents, cleaning up memory space after closing the documents, providing an abstraction to a document storage repository, and validating user access rights before providing access to documents. Various services such as ‘open document service’ 308, ‘refresh service’ 310, etc., are available in the web application server 304. By way of example, a request received at the web application server 304 to open a document is handled by the ‘open document service’ 308 via ‘workspace manager’ 306. Similarly, a request to refresh a document is handled by the ‘refresh service’ 310 via ‘workspace manager’ 306.

When a request to open a document is received, the ‘open document service’ 308 interacts with the ‘workspace manager’ 306 to determine if the document is already opened. If the document is already opened, an existing workspace instance is shared with the user. If the document is not already opened, the document is retrieved from repository 312 or ‘external data source’ 314, and cached in the ‘workspace manager’ 306, and loaded into memory 316. The document loaded into memory 316 is referred to as workspace instance. ‘Workspaces component’ 318 enables opening the document as a workspace instance. ‘Document metadata service’ 320 enables loading of metadata associated with the document. User may click on data in the document and generate graphical visualizations. Such requests to generate graphical visualizations may be in the form of queries. The queries are handled by ‘query service’ 322 in the ‘web application server’ 304. When changes are made to the document and saved, the ‘persistence service’ 324 enables saving the document to the repository 312.

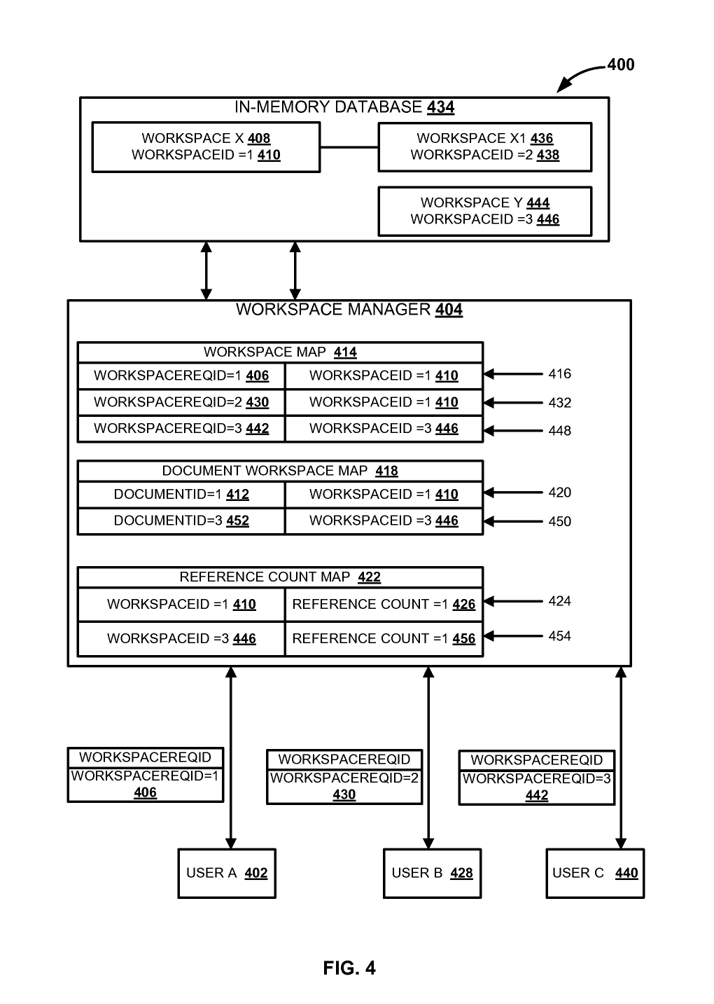

FIG. 4 is a block diagram illustrating an exemplary in-memory workspace management system 400, according to one embodiment. When a document ‘document X’ is opened by ‘user A’ 402, an ‘openworkspace’ request is sent to the workspace manager 404. An individual request from a user is handled by the workspace manager 404. The workspace manager 404 provides a unique identifier such as workspace request identifier represented by ‘workspacereqId’ for the individual request. An individual workspace instance is created or generated in response to the request received from the user, and is identified by a unique workspace identifier represented as ‘workspaceId’. Based on the individual request from the user, a session is established to the workspace instance. The request from ‘user A’ 402 is identified by ‘workspacereqId=1’ 406. A future request from ‘user A’ 402 will be identified with the same workspace identifier ‘workspacereqId=1’ 406.

In response to the request received from ‘user A’ 402 to access ‘document X’, a workspace instance ‘workspace X’ 408 is created, and is identified by workspace identifier ‘workspaceId=1’ 410. ‘Document X’ is identified by a unique document identifier ‘documentId=1’ 412. ‘Workspace manager’ 404 manages a ‘workspace map’ 414 that maintains a mapping 416 between the ‘workspacereqId=1’ 406 and ‘workspaceId=1’ 410. ‘Workspace manager’ 404 manages a ‘document workspace map’ 418 that maintains a mapping 420 between ‘documentId=1’ 412 and ‘workspaceId=1’ 410. ‘Workspace manager’ 404 manages a ‘reference count map’ 422 that maintains a mapping 424 between ‘workspaceId=1’ 410 and a ‘reference count=1’ 426. The reference count is used to track the number of users sharing the workspace instance. Initially, the reference count of ‘workspace X’ instance is set to ‘1’ since ‘user A’ 402 is accessing it.

In one embodiment, when a request is received from ‘user B’ 428 to open the same document ‘document X’, the request is sent to the workspace manager 404. The workspace manager 404 provides a unique identifier ‘workspacereqId=2’ 430 to the request, and also determines whether ‘document X’ is already opened by a different user. Since ‘document X’ is already opened by ‘user A’ 402, the same workspace instance ‘workspace X’ 408 is shared with ‘user B’ 428. Based on the request from ‘user B’ 428, a unique session is established to ‘workspace X’ instance 408. A new mapping 432 between ‘workspacereqId=2’ 430 and ‘workspaceId=1’ 410 is maintained in the workspace map 414. When the ‘workspace X’ instance 408 is shared with ‘user B’ 428, the reference count of ‘workspace X’ instance is incremented to ‘2’. The mapping 424 is updated with ‘workspaceId=1’ 410 and a ‘reference count=2’ (not shown). The session established based on the request from ‘user A’ 402, and the session established based on the request from ‘user B’ 428 are independent of each other though they share the same workspace instance ‘workspace X’ 408. Metadata information associated with ‘user A’ 402 and the metadata information associated with ‘user B’ 428 are maintained in the respective sessions established and there is no overlap.

In one embodiment, ‘user B’ 428 refreshes ‘workspace X’ instance 408 that is currently in use by ‘user A’ 402 and ‘user B’ 428. The request to refresh includes a flag that is set to true such as ‘alterworkspace=true’. When the request to refresh ‘workspace X’ instance 408 is received from ‘user B’ 428, sharing of ‘workspace X’ instance 408 is discontinued for ‘user B’ 428. ‘Workspace X’ instance 408 is forked to create a new workspace instance ‘workspace X1’ 436 with refreshed data from the repository. The new workspace instance ‘workspace X1’ 436 is identified by a unique workspace identifier ‘workspaceId=2’ 438. The flag ‘alterworkspace’ set to ‘true’ initiating forking of the workspace instance. ‘User B’ 428 may work on the new workspace instance ‘workspace X1’ 436, while, ‘user A’ 402 may continue to work on ‘workspace X’ instance 408. During refresh, the workspace map 414 with mapping 432 between ‘workspacereqId=2’ 430 and ‘workspaceId1=1’ 410 is removed, and in the reference count map 422, the reference count to the shared ‘workspace X’ instance 408 is decremented form ‘2’ to ‘1’ (not shown). A request to refresh is merely exemplary, however various types of requests with various flags or other attributes may be used.

In one embodiment, a request is received from ‘user C’ 440 to access a new document ‘document Y’. It is determined whether ‘document Y’ is already opened by a different user. In case ‘document Y’ is not opened by any user, the workspace manager 404 may compare memory available in in-memory database 434 in a server with memory required by ‘document Y’. Based on the comparison, if it is determined that the memory available in the in-memory database 434 is sufficient, ‘document Y’ is loaded into the in-memory database 434 creating a new workspace instance ‘workspace Y’ 444. A cache may be available in the workspace manager 404, and ‘document Y’ may be cached when ‘document Y’ is loaded from a repository to the in-memory database 434 for the first time. The documents may be cached by the workspace manager 404 to avoid delay in retrieving the documents from the repository to in-memory database 434. If it is determined that the memory available in the in-memory database 434 is not sufficient, memory swapping may occur to secure sufficient memory for the ‘document Y’. Whenever a request to open a new document is received, initial memory heuristics of available memory may be performed.

The request is identified by a unique identifier ‘workspacereqId=3’ 442. In response to the request, the new workspace instance ‘workspace Y’ 444 is created when ‘document Y’ is loaded into in-memory database 434. Workspace identifier corresponding to ‘workspace Y’ 444 is ‘workspaceId=3’ 446. The mapping 448 between ‘workspacereqId=3’ 442 and ‘workspaceId=3’ 446 is maintained in the workspace map 414. The mapping 450 between ‘documentId=3’ 452 and ‘workspaceId=3’ 446 is maintained in the document workspace map 418. The mapping 454 between ‘workspaceId=3’ 446 and ‘reference count=1’ 456 is maintained in the reference count map 422. The workspace instance ‘workspaceId=3’ 446 is currently not shared with different user. When the ‘user C’ 440 refreshes the workspace instance ‘workspaceId=3’ 446, latest data is retrieved from the data repository to the workspace instance ‘workspaceId=3’ 442. During refresh, the mapping 450 between ‘documentId=3’ 452 and ‘workspaceId=3’ 446 is removed to avoid further sharing of the workspace instance. In the reference count map 422, the reference count to the workspace instance ‘workspaceId=3’ 446 is retained as ‘reference count=1’ 456. ‘User C’ 440 may change or edit or add graphical representations in ‘document Y’ in the ‘workspace Y’ instance 444. When the document is saved, the workspace manager 404 saves ‘document Y’ in the data repository, and also caches the document for quick future access by different users. When ‘document Y’ is closed, it is determined if the reference count associated to that workspace instance is ‘0’. If the reference count is ‘0’, it implies that no user is sharing the document at the moment, and the resources used by ‘workspace Y’ instance 444 are removed or freed, and accordingly the tables and document are unloaded from memory.

In one embodiment, when a request to access a document is received from a user, access rights or user privileges associated with the user are determined before providing access to the document. Consider a scenario where ‘user A’ 402 and ‘user B’ 428 access the same document by sharing a workspace instance. When ‘user A’ 402 views the document, ‘user B’ 428 tries to delete the document. If it is determined that the privileges of ‘user B’ 428 allows deletion of document, ‘user B’ 428 may delete the document, while, ‘user A’ 402 may continue to work with the document. ‘User A’ 402 may either choose to close the document without saving thereby losing the copy of the document, or, may be prompted to save a copy of that document with a new name or identifier.

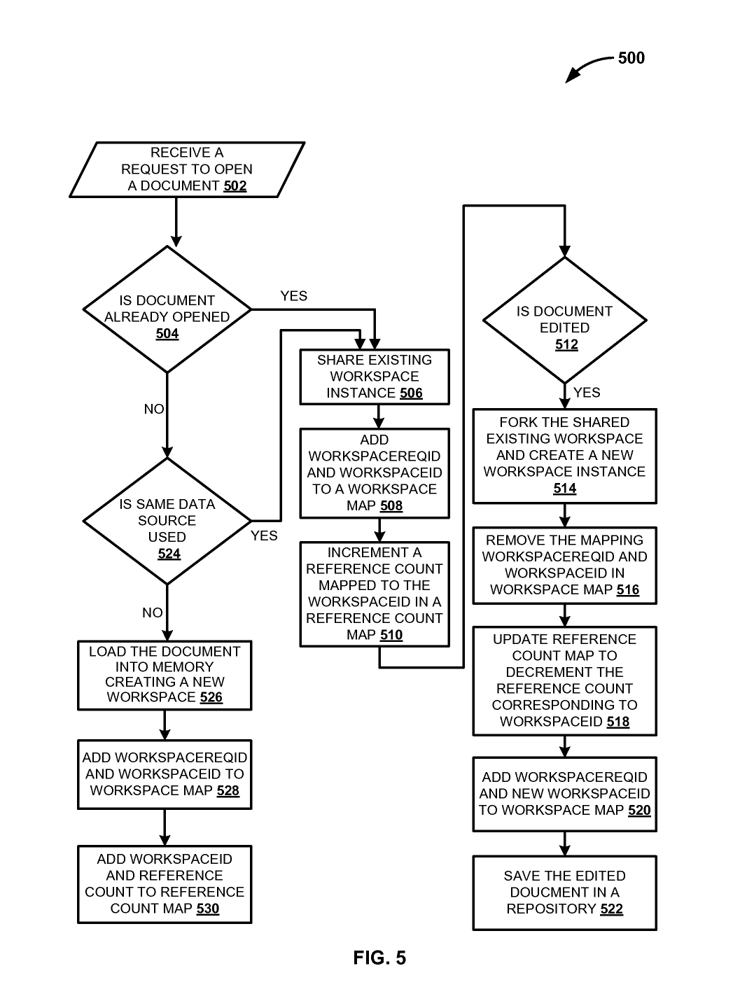

FIG. 5 is a flow diagram illustrating in-memory workspace management 500, according to one embodiment. At 502, a request is received from a user to open a document. At 504, it is determined whether the document is opened. Upon determining that the document is already opened, at 506, an existing workspace instance corresponding to the opened document is shared with the user. At 508, a mapping between ‘workspacereqId’ associated with the request and the ‘workspaceId’ associated with the existing workspace instance is added to a workspace map. At 510, a reference count mapped to the ‘workspaceId’ is incremented since the existing workspace instance is shared with the user. At 512, it is determined whether the document is edited. Upon determining that the document is edited, at 514, the shared existing workspace instance is discontinued from sharing, and is forked to create a new workspace instance for editing. At 516, the mapping between ‘workspacereqId’ and ‘workspaceId’ is removed from the workspace map. At 518, the reference count map is updated to decrement the reference count corresponding to ‘workspaceId’. At 520, a new mapping entry between ‘workspacereqId’ and new ‘workspaceId’ is added in the workspace map. At 522, the edited document is saved in a repository.

Upon determining that the document is not already opened, at 524, it is determined whether the requested document uses the same data source as another document currently loaded in-memory. Upon determining that the same data source is used, steps 506 to 522 may be executed. Upon determining that the same data source is not used, at 526, the document is loaded into memory creating a new workspace instance. At 528, a mapping between the ‘workspacereqId’ and the ‘workspaceId’ is added to the workspace map. At 530, a mapping between the ‘workspaceId’ and a reference count is added to the reference count map. When a new request to open a document is received, the steps in the flow diagram will be executed as appropriate.

By way of example, a sample comparison metrics recorded while accessing documents in case (a) using workspace manager and in case (b) not using the workspace manager is shown below. ‘User A’, ‘user B’ and ‘user C’ open a document ‘sample document’ of size 23 Megabytes. In the case (a), when ‘user A’ opened ‘sample document’ individually using ‘open document service’ call, it took 46 seconds to open the document, and the memory consumption was 100 Megabytes. When ‘user B’ opened ‘sample document’ individually using ‘open document service’ call, it took 47 seconds and the memory consumption was 100 Megabytes. When ‘user C’ opened ‘sample document’ individually using ‘open document service’ call it took 49 seconds and the memory consumption was 100 Megabytes. Memory consumption for the three users was 300 Megabytes. In the case (b), ‘user A’, ‘user B’ and ‘user C’ open the same document ‘sample document’ that was previously opened. ‘Open document service’ call took 320 milliseconds to open document for ‘user A’, 300 milliseconds to open document for ‘user B’, 314 milliseconds to open document for ‘user C’. The memory consumption is 100 Megabytes because the document is shared among the three users. Therefore, workspace manager is advantageous in reducing the memory footprint and improving the performance of the application. The metrics noted above are merely exemplary for the considered sample document.

The workspace manager is advantageous in utilizing the memory in an optimized manner, and also in reducing the document access time, specifically time taken to open the document. The average response time of document is reduced by 6 times or more than that, thereby improving application performance. Memory footprint is reduced by an average factor of 5 times or more. The logic of sharing workspace instance for multiple users in the algorithm explained above does not create conflict between the users. The analytics application is independent of the data storage and retrieval. The workspace manager is advantageous in reducing the memory footprint and improving the performance of the application.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

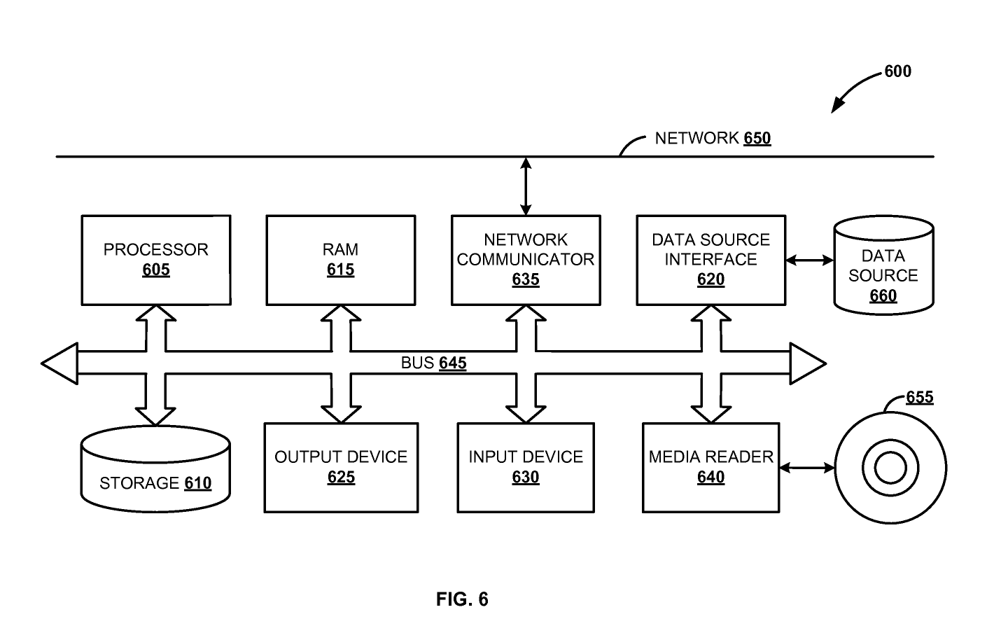

FIG. 6 is a block diagram illustrating an exemplary computer system 600, according to an embodiment. The computer system 600 includes a processor 605 that executes software instructions or code stored on a computer readable storage medium 655 to perform the above-illustrated methods. The processor 605 can include a plurality of cores. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. According to some embodiments, such as some in-memory computing system embodiments, the RAM 615 can have sufficient storage capacity to store much of the data required for processing in the RAM 615 instead of in the storage 610. In some embodiments, all of the data required for processing may be stored in the RAM 615. The stored instructions may be further compiled to generate other representations of the instructions and dynamically stored in the RAM 615. The processor 605 reads instructions from the RAM 615 and performs actions as instructed. According to one embodiment, the computer system 900 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments and examples are described herein for illustrative purposes, various equivalent modifications are possible within the scope, as those skilled in the relevant art will recognize. These modifications can be made in light of the above detailed description.

What is claimed is:

1. A non-transitory computer-readable medium to store instructions, which when executed by a computer, cause the computer to perform operations comprising:
receive a request to access a document;
upon determining that the document is already opened, establish a session to a workspace instance associated with the document, wherein the workspace instance is shared; and
upon determining that the document is edited in the session, fork the workspace instance to create a new workspace instance, wherein the new workspace instance is not shared and is exclusive to the request.

2. The computer-readable medium of claim 1, to store instructions, which when executed by the computer, cause the computer to perform operations:
in response to establishing the session to the workspace instance, add a mapping of a workspace request identifier and a workspace identifier in a workspace map, wherein the request is identified by an workspace request identifier and the workspace is identified by the workspace identifier.

3. The computer-readable medium of claim 1, wherein, when the workspace instance is forked, stop sharing the workspace instance for the request.

4. The computer-readable medium of claim 3, wherein, when sharing the workspace instance is stopped, remove mapping of the workspace request identifier and the workspace identifier in the workspace map.

5. The computer-readable medium of claim 4, to store instructions, which when executed by the computer, cause the computer to perform operations:
increment a reference count to the workspace instance in a reference count map when the workspace instance is shared; and
decrement the reference count to the workspace instance in the reference count map when sharing of the workspace instance is stopped.

6. The computer-readable medium of claim 1, to store instructions, which when executed by the computer, cause the computer to perform operations:
upon determining that the document is not already opened, compare an available memory in a server with a memory required by the document; and
upon determining that sufficient memory required by the document is available, load the document into memory as a workspace instance.

7. The computer-readable medium of claim 1, to store instructions, which when executed by the computer, cause the computer to perform operations:
add visualizations to the new workspace instance associated with the document; and
save the new workspace instance associated with the document in a repository.

8. A computer-implemented method of in-memory workspace management, the method comprising:
receiving a request to access a document;
upon determining that the document is already opened, establishing a session to a workspace instance associated with the document, wherein the workspace instance is shared; and
upon determining that the document is edited in the session, forking the workspace instance to create a new workspace instance, wherein the new workspace instance is not shared and is exclusive to the request.

9. The method of claim 8, further comprising instructions which when executed by the computer further causes the computer to:
in response to establishing the session to the workspace instance, adding a mapping of a workspace request identifier and a workspace identifier in a workspace map, wherein the request is identified by an workspace request identifier and the workspace is identified by the workspace identifier.

10. The method of claim 8, wherein, when the workspace instance is forked, stopping sharing the workspace instance for the request.

11. The method of claim 10, wherein, when sharing the workspace instance is stopped, removing mapping of the workspace request identifier and the workspace identifier in the workspace map.

12. The method of claim 11, further comprising instructions which when executed by the computer further causes the computer to:
incrementing a reference count to the workspace instance in a reference count map when the workspace instance is shared; and
decrementing the reference count to the workspace instance in the reference count map when sharing of the workspace instance is stopped.

13. The method of claim 8, further comprising instructions which when executed by the computer further causes the computer to:
upon determining that the document is not already opened, comparing an available memory in a server with a memory required by the document; and
upon determining that sufficient memory required by the document is available, loading the document into memory as a workspace instance.

14. The method of claim 8, further comprising instructions which when executed by the computer further causes the computer to:
adding visualizations to the new workspace instance associated with the document; and
saving the new workspace instance associated with the document in a repository.

15. A computer system for in-memory workspace management, comprising:
a computer memory to store program code; and
a processor to execute the program code to:
receive a request to access a document;
upon determining that the document is already opened, establish a session to a workspace instance associated with the document, wherein the workspace instance is shared; and
upon determining that the document is edited in the session, fork the workspace instance to create a new workspace instance, wherein the new workspace instance is not shared and is exclusive to the request.

16. The system of claim 15, further comprising instructions which when executed by the computer further causes the computer to:
in response to establishing the session to the workspace instance, add a mapping of a workspace request identifier and a workspace identifier in a workspace map, wherein the request is identified by an workspace request identifier and the workspace is identified by the workspace identifier.

17. The system of claim 15, wherein, when the workspace instance is forked, stop sharing the workspace instance for the request.

18. The system of claim 17, wherein, when sharing the workspace instance is stopped, remove mapping of the workspace request identifier and the workspace identifier in the workspace map.

19. The system of claim 18, further comprising instructions which when executed by the computer further causes the computer to:
increment a reference count to the workspace instance in a reference count map when the workspace instance is shared; and
decrement the reference count to the workspace instance in the reference count map when sharing of the workspace instance is stopped.

20. The system of claim 15, further comprising instructions which when executed by the computer further causes the computer to:
upon determining that the document is not already opened, compare an available memory in a server with a memory required by the document; and
upon determining that sufficient memory required by the document is available, load the document into memory as a workspace instance.
